(19) United States
(12) Patent Application Publication
(10) Pub. No.: US 2009/0190372 A1
(43) Pub. Date: Jul. 30, 2009

(54) SIDE-TYPE BACKLIGHT MODULE

(75) Inventor: Ching-Hua Su, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANO PRECISION CORPORATION, Hsinchu (TW)

(21) Appl. No.: 12/123,469

(22) Filed: May 20, 2008

(30) Foreign Application Priority Data
Jan. 24, 2008 (TW) 97102648

(51) Int. Cl. F21V 7/04; F21V 7/00

(52) U.S. Cl. 362/609; 362/613

(57) ABSTRACT

A side-type backlight module including a lampshade, a light guide plate (LGP), a plurality of point light sources and a reflection structure is provided. The LGP has a light incident surface disposed at an opening of the lampshade. The point light sources are disposed between the lampshade and the LGP. The reflection structure is disposed between the LGP and the lampshade, and has first light outlets, at least a second light outlet, sinks, first reflecting elements and at least a second reflecting element. The sinks are disposed corresponding to the first light outlets. The point light sources are disposed in the sinks. The second light outlet is located between and adjacent to the first light outlets. The first reflecting elements are disposed at the junctions of each first light outlet and the second light outlet. The second reflecting element is disposed corresponding to the second light outlet.

### CROSS-REFERENCE TO RELATED APPLICATION

This application claims the priority benefit of Taiwan application serial no. 97102648, filed on Jan. 24, 2008. The entirety of the above-mentioned patent application is hereby incorporated by reference herein and made a part of specification.

### BACKGROUND OF THE INVENTION

1. Field of the Invention

The present invention generally relates to a backlight module and, more particularly, to a side-type backlight module.

2. Description of Related Art

FIG. 1 is a cross-sectional diagram of a conventional side-type backlight module. Referring to FIG. 1, a side-type backlight module 100 includes a plurality of light emitting diode (LED) light sources 110, a lampshade 120, a light guide plate (LGP) 130 and a reflecting plate (not shown). The LGP 130 has a light incident surface 132 and a light emitting surface 134, and the LED light sources 110 are disposed at the light incident surface 132. Each of the LED light sources 110 is capable of emitting an illumination beam L10. The illumination beam L10 enters the LGP 130 via the light incident surface 132, and the LGP 130 and the reflecting plate make the illumination beam L10 depart from LGP 130 via the light emitting surface 134. The departed illumination beam L10 functions as a surface light source.

Since the LEDs are arranged in a straight line and since the LED light sources have high directivity, the LED light sources 110 form bright stripes on the light incident surface 132 of the LGP 130 and form dark stripes on the parts of the light incident surface 132 of the LGP 130 between the LED light sources. As such, the illumination beam L10 emitted from the light emitting surface 134 is non-uniform.

### SUMMARY OF THE INVENTION

Accordingly, the present invention is directed to a side-type backlight module capable of emitting a more uniform illumination beam.

An embodiment of the present invention provides a side-type backlight module, which includes a lampshade, a light guide plate (LGP), a plurality of point light sources and a reflection structure. The lampshade has an opening. The LGP has a light incident surface and a light emitting surface adjacent to the light incident surface, and the light incident surface is disposed at the opening. The point light sources are disposed between the lampshade and the LGP, and each of the point light sources is capable of emitting an illumination beam. The reflection structure is disposed between the LGP and the lampshade. The reflection structure has a plurality of first light outlets, at least a second light outlet, a plurality of sinks, a plurality of first reflecting elements and at least a second reflecting element. The sinks are disposed corresponding to the first light outlets respectively. The point light sources are disposed in the sinks. The second light outlets are located between the first light outlets and adjacent to the first light outlets. The first reflecting elements are respectively disposed at the junctions of the first light outlets and the second light outlets. The second reflecting element is disposed corresponding to the second light outlet so as to make the second reflecting element located between the sinks. A part of each of the illumination beams strikes the light incident surface via one of the first light outlet, and another part thereof is sequentially reflected by one of the first reflecting elements and the second reflecting element, and strikes the light incident surface via the second light outlet.

In the above-mentioned embodiment of the present invention, since a reflection structure is disposed between the point light sources and the LGP and since the first reflecting elements and the second reflecting element of the reflection structure are capable of adjusting the illumination beams, dark regions on the LGP is reduced, and leakage light of the light emitted from the point light sources to the LGP is avoided, which makes the illumination beams uniformly strike the light incident surface of the LGP and thereby promoting the uniformity of the illumination beams emitted from the light emitting surface of the LGP.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional diagram of a conventional side-type backlight module.

FIG. 2 is a cross-sectional diagram of a side-type backlight module according to an embodiment of the present invention.

FIG. 3 is a 3-D diagram of the reflection structure in FIG. 2.

FIG. 4 is a 3-D diagram viewed from another angle of the reflection structure in FIG. 2.

FIG. 5 is a cross-sectional diagram of the reflection structure in FIG. 2.

FIGS. 6-8 are cross-sectional diagrams of reflection structures according to other embodiments of the present invention.

FIG. 9 is a cross-sectional diagram of a side-type backlight module according to another embodiment of the present invention.

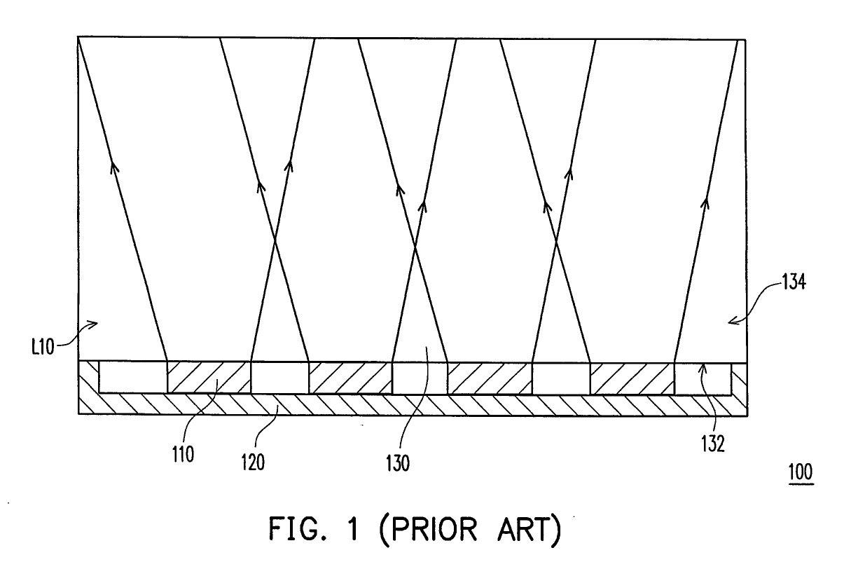

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

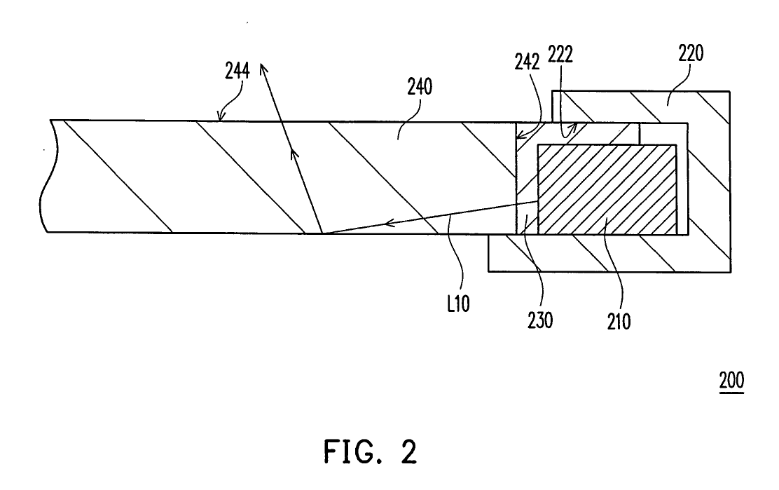

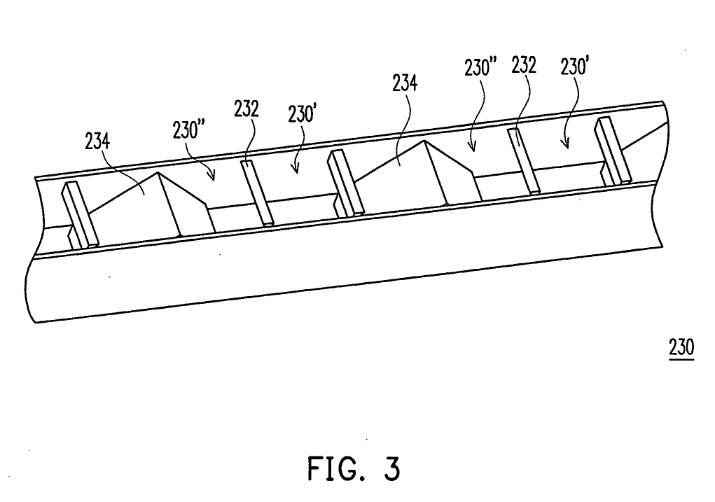

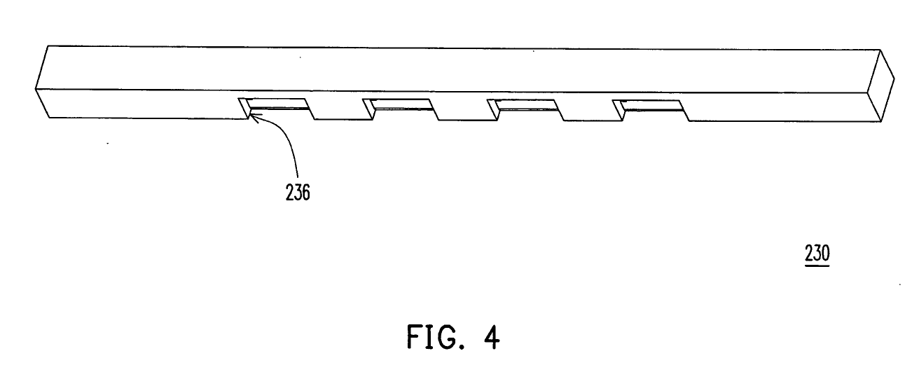

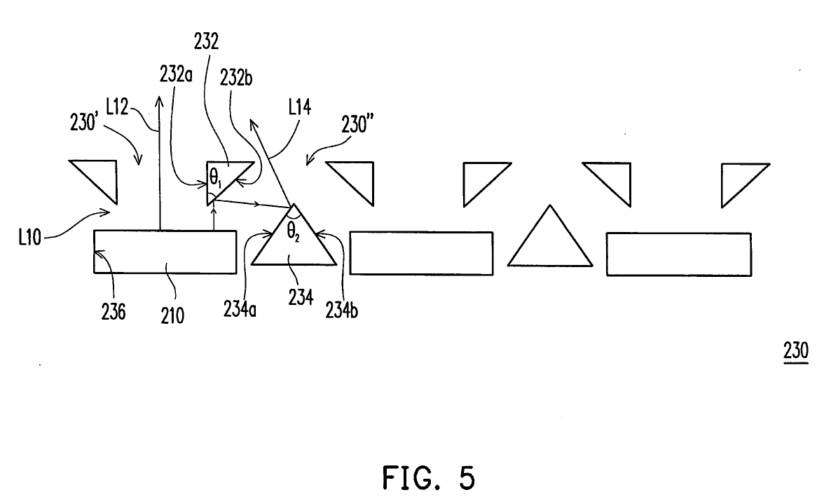

FIG. 2 is a cross-sectional diagram of a side-type backlight module according to an embodiment of the present invention, FIG. 3 is a 3-D diagram of the reflection structure in FIG. 2, FIG. 4 is a 3-D diagram viewed from another angle of the reflection structure in FIG. 2, and FIG. 5 is a cross-sectional diagram of the reflection structure in FIG. 2. Referring to FIGS. 2-5, a side-type backlight module 200 includes a plurality of point light sources 210 (only one shown in the figures), a lampshade 220, a reflection structure 230 and an LGP 240. The point light sources 210 are, for example, light emitting diodes, and each of the point light sources 210 emits an illumination beam L10, and the point light sources 210 and the reflection structure 230 are disposed between the lampshade 220 and the LGP 240. The lampshade 220 has an opening 222, the LGP 240 has a light incident surface 242 and a light emitting surface 244, and the light incident surface 242 is adjacent to the light emitting surface 244. The light incident surface 242 is disposed at the opening 222, and the reflection structure 230 is disposed at the light incident surface 242.

The reflection structure 230 has a plurality of first light outlets 230′, at least a second light outlet 230″ (in the present embodiment, a plurality of second light outlets 230″ are taken as an example), a plurality of first reflecting elements 232, at least a second reflecting element 234 (in the embodiment, a plurality of second reflecting elements 234 are taken as an example) and a plurality of sinks 236. The first light outlets 230′ and the second light outlets 230″ are located at the light incident surface 242, and the first light outlets 230′ and the second light outlets 230″ are adjacent to each other and alternately arranged. One of the first reflecting elements 232 is disposed at the junction of each of the first light outlets 230′ and each of the second light outlets 230″, and one of the second reflecting elements 234 is disposed corresponding to each of the second light outlets 230″, so that the second reflecting elements 234 are respectively located between the sinks 236.

Referring to FIGS. 2 and 5, the sinks 236 is disposed corresponding to the first light outlets 230′ respectively, and the point light sources 210 are respectively disposed in the sinks 236. When each of the illumination beams L10 passes through one of the first light outlets 230′, the illumination beam L10 is divided by each first reflecting element 232 into a first partial beam L12 and a second partial beam L14. The first partial beam L12 is emitted out from the first light outlets 230′ and enters the LGP 240 via the light incident surface 242. The second partial beam L14 is reflected by the first reflecting element 232, reflected by the second reflecting element 234, emitted out from the second light outlets 230″, and then enters the LGP 240 via the light incident surface 242. The first partial beam L12 and the second partial beam L14 travel through the LGP 240 and then are emitted out from the light emitting surface 244 so as to form a surface light source.

Since one of the second reflecting elements 234 is disposed between each of the point light sources 210 in the reflection structure 230, each of the first partial beams L12 is emitted out from the first light outlet 230′, and each of the second partial beams L14 is reflected by the first reflecting element 232 and the second reflecting element 234 and then emitted out from the second light outlet 230″. In this way, the luminance of the emitted light at the first light outlet 230′ is reduced and the luminance of the emitted light at the second light outlet 230″ is enhanced. In other words, the bright stripe and the dark stripe are lightened, which further increases the uniformity of the illumination beams L10 of the LGP 240 and promote the illumination quality of the side-type backlight module 200.

In the present embodiment, each of the first reflecting elements 232 has a first reflecting plane 232a and a second reflecting plane 232b. The first reflecting plane 232a faces the first light outlet 230′ and the second reflecting plane 232b faces the second light outlet 230″. The first reflecting element 232 is a triangle, and the included angle θ₁ between the first reflecting plane 232a and the second reflecting plane 232b ranges between 0° and 60°. The second reflecting element 234 has a third reflecting plane 234a and a fourth reflecting plane 234b. The second reflecting element 234 is a triangle as well, and the included angle θ₂ between the third reflecting plane 234a and the fourth reflecting plane 234b ranges between 30° and 120°. Each of the reflecting planes is formed by applying a coating with high reflectance on the first reflecting element 232 and the second reflecting element 234, or by using a material with high refractive index to fabricate the first reflecting element 232 and the second reflecting element 234.

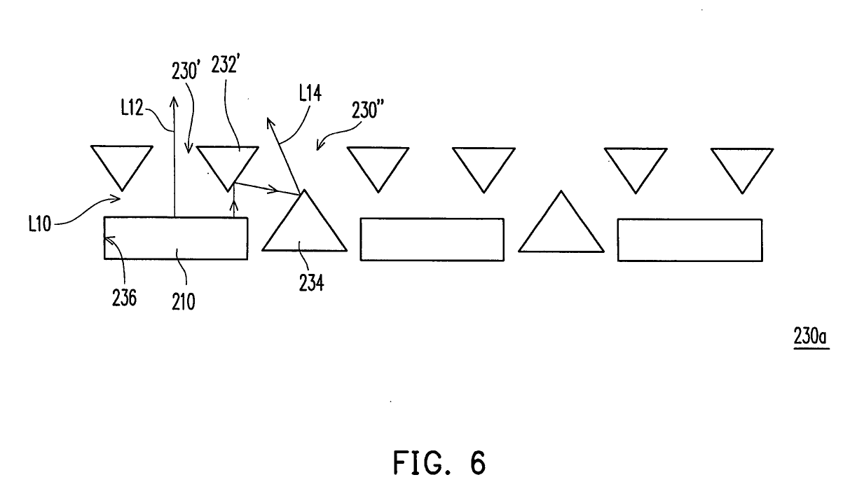

Note that the first reflecting elements 232 and the second reflecting elements 234 may be implemented with other shapes. FIGS. 6-8 are cross-sectional diagrams of reflection structures according to other embodiments of the present invention. Note that the embodiments of FIGS. 6-8 are partially similar to the embodiment in FIG. 5. All the same or similar components are notated in the same or similar marks in the embodiments of FIGS. 6-8 and the embodiment of FIG. 5. Only unique is described in detail hereinafter, and all the same features are omitted to describe.

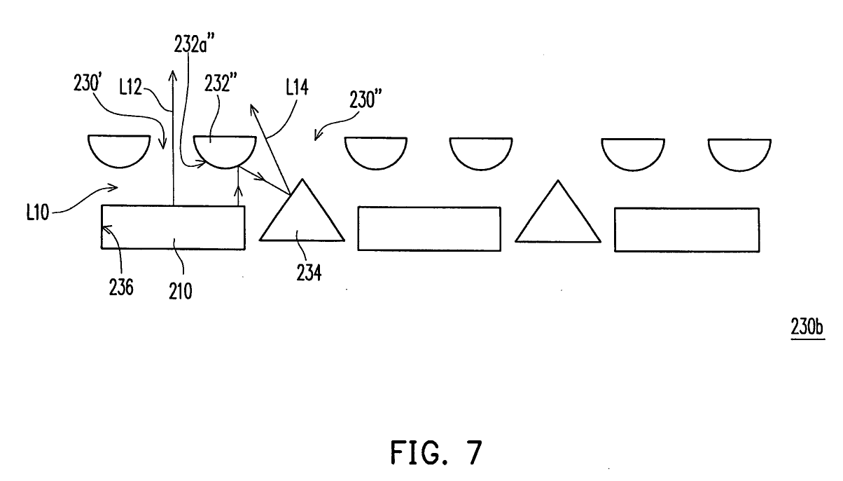

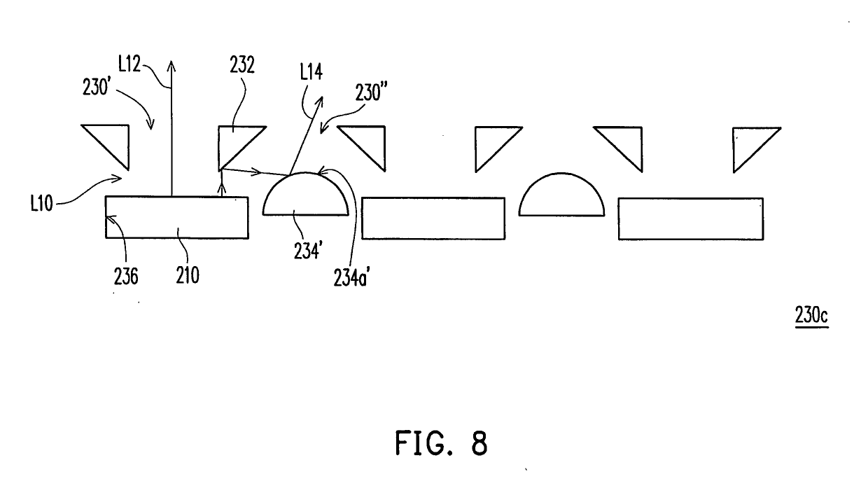

Referring to FIG. 6, in the present embodiment, the first reflecting element 232′ of a reflection structure 230a is an isosceles-triangle. Referring to FIG. 7, in the present embodiment, the first reflecting element 232″ of a reflection structure 230b has a first reflecting curve surface 232a″. Referring to FIG. 8, in the present embodiment, the second reflecting element 234′ of a reflection structure 230c has a second reflecting curve surface 234a′.

In the above-described embodiments, a plurality of second light emitting surfaces are taken as examples, but the present invention is not limited thereto. For example, the reflection structure may have only one second light emitting surface located between two of the first light emitting surfaces.

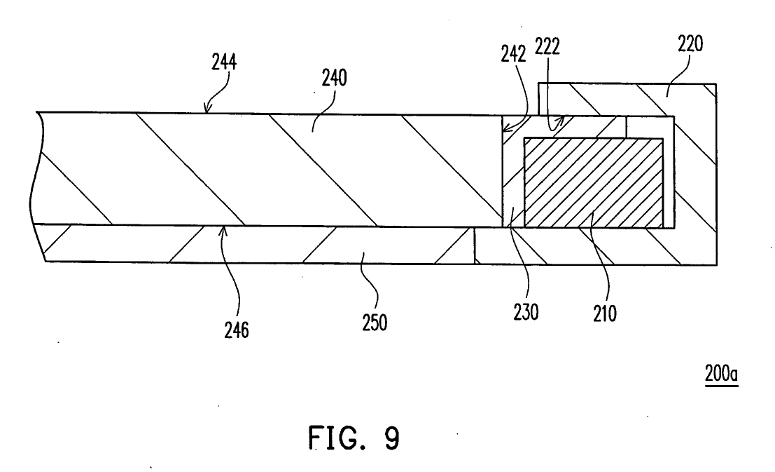

FIG. 9 is a cross-sectional diagram of a side-type backlight module according to another embodiment of the present invention. Note that the embodiment is partially similar to the embodiment of FIG. 2. All the same or similar components are notated in the same or similar marks in the present embodiment and the embodiment of FIG. 2. Only unique is described in detail hereinafter, and all the same features are omitted to describe.

Referring to FIG. 9, in the present embodiment, a side-type backlight module 200a further includes a reflecting plate 250. The LGP 240 further includes a reflecting surface 246. The reflecting surface 246 is adjacent to the light incident surface 242, and opposite to the light emitting surface 244. The reflecting plate 250 is disposed at the reflecting surface of the LGP 240 for promoting the usage efficiency of the illumination beam L10.

In summary, in the above-described embodiments of the present invention, the second reflecting elements are respectively disposed between the point light sources in the reflection structure, and a part of each of the illumination beams is reflected by one of the first reflecting elements and one of the second reflecting elements and then is emitted out from one of the second light outlets, which contributes to lighten the dark stripes between the point light sources and the dark stripes at the point light sources, reduce the dark region on the LGP, avoid the leakage light between the point light sources and the LGP, and increase the uniformity of the illumination beams striking the LGP, thereby promoting the illumination quality of the side-type backlight module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A side-type backlight module, comprising:
a lampshade, having an opening;
a light guide plate, having a light incident surface and a light emitting surface adjacent to the light incident surface, wherein the light incident surface is disposed at the opening;
a plurality of point light sources, disposed between the lampshade and the light guide plate, wherein each of the point light sources is capable of emitting an illumination beam; and
a reflection structure, disposed between the light guide plate and the lampshade and having a plurality of first light outlets, at least a second light outlet, a plurality of sinks, a plurality of first reflecting elements and at least a second reflecting element, wherein the sinks are disposed corresponding to the first light outlets respectively, the point light sources are disposed in the sinks, the second light outlet is located between the first light outlets and adjacent to the first light outlets, the first reflecting elements are respectively disposed at junctions of the first light outlets and the second light outlet, the second reflecting element is disposed corresponding to the second light outlet, and the second reflecting element is located between the sinks,
wherein a part of each of the illumination beams strikes the light incident surface via the first light outlet, and another part of each of the illumination beams is sequentially reflected by the first reflecting element and the second reflecting element and strikes the light incident surface via the second light outlet.

2. The side-type backlight module according to claim 1, wherein at least a second light outlet comprises a plurality of second light outlets.

3. The side-type backlight module according to claim 1, further comprising a reflecting plate disposed on a surface of the light guide plate opposite to the light emitting surface.

4. The side-type backlight module according to claim 1, wherein each of the first reflecting elements has a first reflecting plane and a second reflecting plane, the first reflecting plane faces the first light outlet, the second reflecting plane faces the second light outlet, and an included angle between the first reflecting plane and the second reflecting plane ranges between 0° and 60°.

5. The side-type backlight module according to claim 1, wherein each of the first reflecting elements has a first reflecting curve surface.

6. The side-type backlight module according to claim 1, wherein the first reflecting elements are triangles.

7. The side-type backlight module according to claim 1, wherein the second reflecting element has a third reflecting plane and a fourth reflecting plane, and an included angle between the third reflecting plane and the fourth reflecting plane ranges between 30° and 120°.

8. The side-type backlight module according to claim 1, wherein the second reflecting element has a second reflecting curve surface.

9. The side-type backlight module according to claim 1, wherein the second reflecting element is a triangle.
